(19) United States
(12) Patent Application Publication
(10) Pub. No.: US 2024/0026994 A1
(43) Pub. Date: Jan. 25, 2024

(54) RETAINING COMPONENT

(71) Applicant: LISA DRÄXLMAIER GMBH, Vilsbiburg (DE)

(72) Inventors: Simon HUBER, Landshut (DE); Martin BIBERGER, Landshut (DE); Rainer PEUKE, Andermannsdorf (DE); Andreas NEUMAYER, Geisenhausen (DE)

(73) Assignee: LISA DRÄXLMAIER GMBH, Vilsbiburg (DE)

(21) Appl. No.: 18/481,064

(22) Filed: Oct. 4, 2023

Related U.S. Application Data
(63) Continuation of application No. PCT/EP2022/057363, filed on Mar. 21, 2022.

(30) Foreign Application Priority Data
Apr. 20, 2021 (DE) 10 2021 109 919.6

(51) Int. Cl. F16L 3/10; B60R 16/02

(52) U.S. Cl. CPC F16L 3/1091; B60R 16/0215

(57) ABSTRACT

A retaining component for securing at least one cable, includes a main body with a base and a foot element formed on the base. Two webs extend from the base. Both webs extend essentially parallel to one another in the longitudinal direction and form a receiving area for receiving at least one cable. At least one of the webs includes a latching element disposed on an outer side configured to be brought into friction-locking and/or positive-locking engagement with a cover element. The cover element features two holes configured to be brought into engagement with the latching element of a web of the retaining component in a closed position. The cover element is connected to the retaining component to produce a friction-locking and/or positive-locking connection between the webs and the cover element.

### CROSS-REFERENCE TO RELATED APPLICATIONS

This application is a continuation of International Application No. PCT/EP2022/057363, filed on Mar. 21, 2022, which claims priority to and the benefit of DE 10 2021 109 919.6 filed on Apr. 20, 2021. The disclosures of the above applications are incorporated herein by reference.

### FIELD

The present disclosure relates to a retaining component for bundling at least one cable and for fixing the at least one cable on the chassis of a vehicle.

### BACKGROUND

The statements in this section merely provide background information related to the present disclosure and may not constitute prior art.

Cable ties or wrapping tape are used as a general rule in the manufacture of wiring harnesses in automobile construction for bundling at least one cable or a cable bundle and fixing the at least one cable on the chassis. These retaining components known from the prior art are ideal for manual manufacture, but automation is increasingly used in the production of wiring harnesses. However, the automated manufacture of retaining components affixed with cable ties or with wrapping tape is laborious, expensive, and complex. This makes the automation more difficult for the production of wiring harnesses.

### SUMMARY

This section provides a general summary of the disclosure and is not a comprehensive disclosure of its full scope or all of its features.

The present disclosure provides a retaining component which makes possible an automated attachment of retaining components for bundling at least one cable or a cable bundle and fixing the wiring harness on the chassis.

The present disclosure is based upon the realization that the automated attachment of retaining components can be achieved by means of a retaining component having two relatively rigid webs, which extend essentially parallel to one another and thereby form an essentially U-shaped receiving area for receiving at least one cable. At least one of these rigid webs has corresponding latching elements or ribs on an outer side of the web, which can be brought into friction-locking and/or positive-locking engagement with a cover element. The cover element is thus placed on the two webs of the retaining component and forms a closed-off receiving area for the cables located in the receiving area. The attachment of the cover element on the webs of the retaining component can advantageously take place, for example, via automated methods such as possibly a robot-like gripping arm.

The retaining component can be attached in an automated manner to cable bundles with a small to moderately sized bundle diameter. When using the retaining component according to the present disclosure, a simple linear motion is thus sufficient to attach the retaining component on the wiring harness, which advantageously enables an automatable attachment of a retaining component on the wiring harness.

According to one aspect of the present disclosure, the disclosure relates to a retaining component which enables an automated attachment of retaining components for bundling at least one cable or a cable bundle and fixing the wiring harness on the chassis, including a main body with a base and a foot element formed on the base. Two yokes designed as webs extend from the base in the longitudinal direction of the retaining component contrary to the longitudinal direction of the foot element. The two webs extend essentially parallel to one another in the longitudinal direction and thus form a receiving area for receiving at least one cable. At least one of the webs features a latching element on an outer side of the web, which is designed to be brought into friction-locking and/or positive-locking engagement with a cover element. The cover element features two pass-through areas, which are configured to be respectively brought into engagement with the latching element of one of the webs of the retaining component in a closed position in which the cover element is connected to the retaining component. A a friction-locking and/or positive-locking connection can be produced between the webs and the cover element.

In one form, the latching element is designed only on one of the webs. The retaining component is made in a simple and cost-effective way.

In one variation, the cover element features a cutout section which faces in the direction of the receiving area. In this way is achieved the advantage that the cable bundle, which is to be clamped or bundled, and which is configured round, can be enclosed in a positive-locking manner, which provides a particularly good hold within the retaining component.

In one form, the main body and the base are arranged at an angle to one another. In this way is achieved the advantage that the retaining component can also be mounted within a vehicle in a 9 o'clock or 12 o'clock position.

In one variation, the retaining component and the cover element are made of plastic. In this way is achieved the advantage that the retaining component and the cover element can be especially cost-effectively produced.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1A shows a front view of a retaining component with a cover element in accordance with one form of the present disclosure;

FIG. 1B shows a cross-sectional view of the retaining component of FIG. 1A in accordance with one form of the present disclosure;

FIG. 1C shows a perspective view of the retaining component of FIG. 1A in accordance with one form the present disclosure;

FIG. 2 shows a perspective view of a retaining component of FIG. 1A in accordance with one form the present disclosure;

FIG. 3A shows a front view of a retaining component with a cover element in an accordance with another form of the present disclosure;

FIG. 3B shows a cross-sectional view of the retaining component of FIG. 3A in accordance with the present disclosure;

FIG. 4 shows a perspective view of the retaining component in accordance with another form of the present disclosure; and

FIG. 5 shows a transport device for attaching and fixing a retaining component in accordance with one form of the present disclosure.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

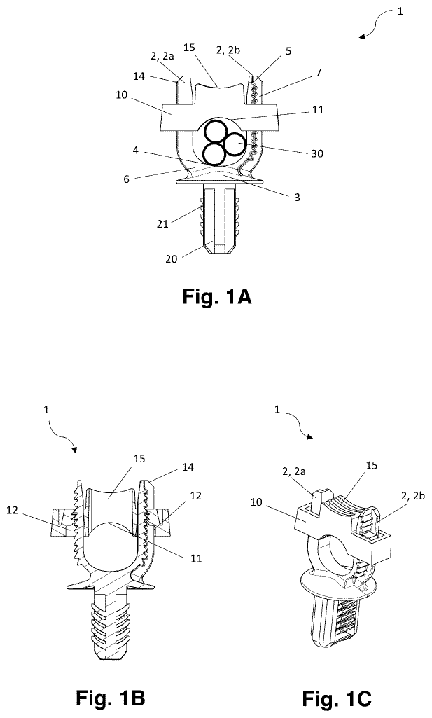

FIG. 1A schematically depicts the retaining component 1, according to the present disclosure, for securing a number of cables 30 to a main body 6 with a base 3 and a foot element 6 formed on the base 3. Two yokes, configured as webs 2, 2a, 2b, extend from the base 3 contrary to a longitudinal direction of the foot element 6 in a longitudinal direction of the retaining component 1. The two webs 2, 2a, 2b extend essentially parallel to one another in a longitudinal direction and thereby form a receiving area 4 for receiving the cables 30, which is U-shaped in an exemplary variation. The receiving area 4 can, however, also have a different shape. For example, the receiving area 4 can be configured straight. The foot element 20 is configured as an elongated element having a base plate 21, for example, latching elements, which make possible a connection of the retaining component 1 to a (not depicted) chassis element of a vehicle.

In the variation depicted in FIG. 1B, a cover element 10 includes a press-on element 15. In the exemplary variation, the press-on element 15 is provided with a radius configured inwardly in direction of the cover element 10, so that the cover element 10 can be more easily pressed down, for example, by a production worker, who can thus press their thumb on the press-on element 15, upon assembly of the cover element 10 onto the webs 2, 2a, 2b. The press-on element 15 can, however, also have a different shape, so that an easier pressing of the cover element 10 into the webs 2a, 2b is possible.

FIG. 1C shows a form of a retaining component 1 which differs from the retaining components 1 depicted in FIGS. 1A and 1B only in that the press-on element 15 features a surface which is provided with ribs, which makes assembly easier for a production worker to press the cover element 10 into the webs 2, 2a, 2b with his or her thumb without the worker's thumb slipping from the press-on element 15. The surface of the press-on element 15, which is roughened by the incorporated ribs, thus provides for a better grip on the cover element 10 during assembly.

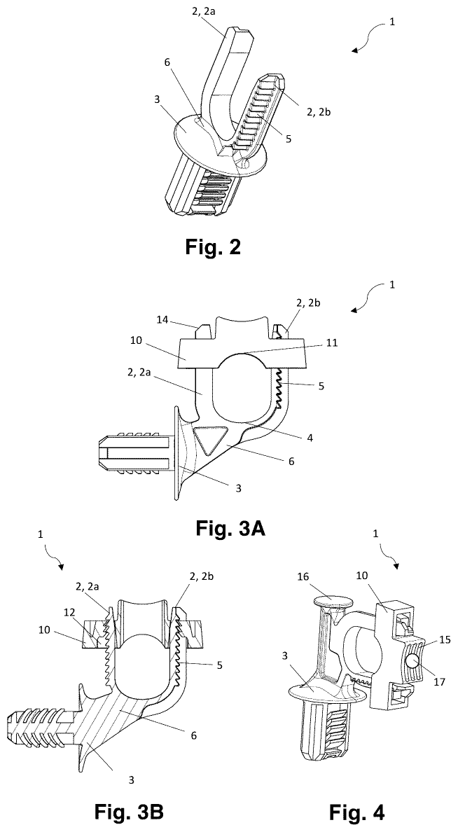

As can be seen in FIG. 1A, each web 2, 2a, 2b features a latching element 5 disposed on an outer side 7 of the web 2, 2a, 2b, which is configured to be brought into friction-locking and/or positive-locking engagement with a cover element 10. The latching element 5 can thereby be formed from a number of protruding ribs. FIGS. 1B and 2 show, another variation for only one latching element 5 to be configured on only one of the webs 2, 2a, 2b.

As can be seen in FIG. 1B, the cover element 10 features two pass-through areas designed as holes 12, which are each configured to be brought into engagement with the respective latching element 5 of the web 2, 2a, 2b of the retaining component 1 in a closed position in which the cover element 10 is connected to the retaining component 1, so that a friction-locking and/or positive-locking connection between the webs 2, 2a, 2b and the cover element 10 can be produced.

FIG. 1B shows a retaining component 1 in which the cover element 10 features a cutout section 11 which faces in direction of the receiving area 4 of the retaining component 1. The cutout section 11 can feature a radially-configured notch, into which the bundled cables (not depicted) can be correctly pressed. However, the notch can also have a different shape and does not necessarily need to be configured radially, but can rather be configured, for example, straight or can feature a straight segment.

FIGS. 3A and 3B show variations of retaining components 1 in which the main body 6 and the base 3 are located at an angle to the foot element 20. In the depicted example, the angle is approximately 90°. Other angular positions are, however, possible.

FIG. 4 shows a form of a retaining component 1 in which the base 3 is arranged at an angle with respect to the webs 2, 2a, 2b or the cover element 10. In one form, the retaining component 1 includes a pressure element 16, which is configured, for example, radially—other shapes are possible—in order to simplify the manual installation or the placement of the retaining component 1, for example, in a chassis element (not depicted) by a production worker if the worker presses his or her thumb on the pressure element 16. The surface of the press-on element 15 further features a gripping element 17, which is configured as an opening or a hole. The gripping element 17, which can be configured, for example, as a conical indentation, an engagement element (not depicted), which features, for example, a conical centering pin, can slide into the opening and engage with the retaining element for transport during an automated processing of the retaining component 1.

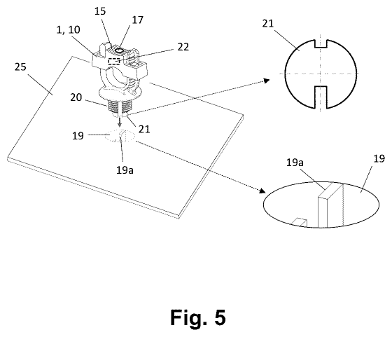

The variation depicted in FIG. 5 is designed for automated processing of the retaining component 1 according to the present disclosure. FIG. 5 shows an example for simplified transport of a plurality of retaining components 1, wherein the foot element 20 is inserted and fixed with the base plate 21, for example, in a plate provided with a corresponding receiving element 19 and configured as a flat transport device 25. FIG. 5 shows the receiving element 19 in the flat transport device 25 as an example. The receiving element 19 features engagement elements 19a corresponding to the foot element 20 and provided with cutouts, which can receive the base plate 21, which is formed by means of notches, of the respective foot element 20 of the receiving element 19. The retaining component 1 can be fixed in the respective receiving element 19, for example, in that the retaining component 1 is screwed into the receiving element 19 in a similar manner as the screwing in of a screw, which inhibits the retaining component 1 from falling out during transportation of the flat transport device 25. Other forms for detachably fixing the retaining component 1—not depicted here—to the receiving element 19, such as, for example, via a corresponding friction-locking and/or positive-locking or via clipping, are also possible.

In the variation from FIG. 5, the cover element 10 also features a gripping element 17 on the surface of the press-on element 15, which can be designed as an indentation, so that a centering pin on a gripper (not depicted) can engage with the retaining component 1. Variations in the pickup position of the retaining component 1 due to the robot-like gripper can be compensated with a conically-configured indentation as well as the corresponding conically-configured centering pin on the gripper. A centering is additionally made possible by the gripper arm of the gripper when the wiring harness grips onto the retaining component.

A camera system (not depicted) could be installed on the gripper, which can be oriented using so-called reference marks 22 or fiducial marks, which are geometrically distinct identifying markings for positioning the component, as further support for an easier gripping of the retaining component 1. Such a reference mark 22, as depicted as an example in FIG. 5, could be placed, for example, at the designated position of the retaining component 1 and could be realized without a great deal of effort on the injection molded component.

The gripping element 17, as depicted on the retaining component 1 according to FIG. 5, provides a defined positioning of the retaining component 1 and thus also a defined positioning of the wiring harness on the transport route to the customer. The defined positioning provides the correct position and orientation of the retaining component at the customer. The combination of both features of the gripping element 17 and the reference mark 22 results in the customer being able to grip the correctly oriented and centered retaining component 1 and install the retaining component 1 in the chassis with the help of a robot arm. The automated installation of the retaining component 1 with the wiring harness attached thereto is made possible at the customer.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A retaining component for securing at least one cable, the retaining component comprising:
a main body having a base and a foot element formed on the base,
two webs extending from the base, wherein each of the two webs include an outer side,
wherein the two webs extend parallel to one another in a longitudinal direction to form a receiving area for receiving at least one cable, and
wherein at least one of the webs includes a latching element disposed on the outer side of the web, and
a cover element, wherein the cover element comprises two holes configured to be brought into an engagement with the latching element of at least one of the webs, and
wherein, in a closed position, the engagement is at least one of friction-locking and positive-locking.

2. The retaining component according to claim 1, wherein the cover element includes a cutout section facing a direction of the receiving area.

3. The retaining component according to claim 1, wherein the main body and the base are arranged at an angle to one another.

4. The retaining component according to claim 1, wherein the main body and the foot element are arranged at an angle to one another.

5. The retaining component according to claim 1, wherein the retaining component and the cover element are made of plastic.
